(19) United States
(12) Patent Application Publication
(10) Pub. No.: US 2014/0380007 A1
(43) Pub. Date: Dec. 25, 2014

(54) BLOCK LEVEL STORAGE

(71) Applicants: Chun-Hui Suen, Singapore (SG); Markus Kirchberg, Singapore (SG); Bu Sung Lee, Singapore (SG)

(72) Inventors: Chun-Hui Suen, Singapore (SG); Markus Kirchberg, Singapore (SG); Bu Sung Lee, Singapore (SG)

(73) Assignee: Hewlett-Packard Development Company, L.P., Houston, TX (US)

(21) Appl. No.: 14/371,709

(22) PCT Filed: Apr. 30, 2012
(86) PCT No.: PCT/US2012/035908

§ 371 Date: Jul. 10, 2014

(51) Int. Cl. G06F 3/06

(52) U.S. Cl. CPC G06F 3/065; G06F 3/0619; G06F 3/067; G06F 2212/1032; G06F 2212/1048; G06F 2212/263
USPC 711/162

(57) ABSTRACT

A storage system comprises a front-end processing subsystem to receive block level storage requests and a plurality of back-end storage nodes coupled to the front-end subsystem. Each of the back-end storage nodes comprises a storage device and a block manager to create, read, update and delete data blocks on the storage device. The front-end processing subsystem maintains a plurality of block reference data structures that are usable by the front-end processing subsystem to access the back-end data storage nodes to provide balancing, redundancy, and scalability to the storage system.

### BACKGROUND

Block level storage involves the creating of raw storage volumes. Server-based operating systems connect to these volumes and use them as individual hard drives. Block level storage services may be based on file or volume representations. In a file representation, files can be shared with various users. By creating a block-based volume and then installing an operating system or file system and attaching to that volume, files can be shared using the native operating system. In a volume representation, each volume is attached to a specific machine offering raw storage capacity.

### BRIEF DESCRIPTION OF THE DRAWINGS

For a detailed description of various examples, reference will now be made to the accompanying drawings in which:

FIG. 1A shows a system in accordance with an example;

FIG. 1B shows a hardware diagram in accordance with an example;

FIG. 2 shows an example of a block reference data structure;

FIG. 3 shows an example of a read transaction method;

FIG. 4 shows another example of a read transaction method;

FIG. 5 shows an example of a write transaction method; and

FIG. 6 shows another example of a write transaction method.

### DETAILED DESCRIPTION

As noted above, block storage services may be based on file or volume representations. A volume comprises an array of fixed-size blocks. While such approaches have been proven suitable for centralized storage environments, these approaches are not particular suitable as the foundation of high-performance distributed block storage services that provision storage services to virtualized machine environments, particularly in the cloud environment. In the cloud environment, numerous (e.g., hundreds or thousands) physical or virtual computing machines may need to access a common cloud-based storage service. Physical machines used to host virtual machines typically have a small footprint for software needed to manage the virtual machines, but virtual machines providing end-user operating system software and services may have a large need for storage.

It is also desirable to allocate storage to virtual machines in a dynamic fashion. That is, storage space allocation should be on-demand (i.e., post-allocation, meaning after the storage space allocation during system initialization). As virtual machines are deployed, they often are instantiated using a standard operating system image whose system files may remain unchanged during the use of the virtual machines. Updates are mainly applied to system configuration files, custom applications and user space files. As a result, support for data deduplication is desirable.

Besides using standard operating system images, cloud storage services should allow clients to save a snapshot of their running virtual machine including, for example, the operating system kernel, applications, and user space files. Such a snapshot may be useful as, for example, a backup or as a blueprint for instantiating other similar virtual machines, and such virtual machines can be spawned on-demand (i.e., when needed).

Various examples of a storage infrastructure are described herein that address some or all of these issues. In general, the disclosed examples comprise a block level storage system that is based on database technology for its back-end storage needs. By combining database technology in a block level storage system, the resulting storage system is robust and scalable. The storage system described herein achieves scalability, redundancy, and balancing. Scalability refers to the ability of the storage system to handle increasingly higher workload by using additional storage nodes, and enables the storage system's use in, for example, a cloud environment. Redundancy refers to the ability of the storage system to replicate blocks to one or more storage nodes. Balancing refers to the ability of the storage system to distribute read and write requests among the various storage nodes and also to migrate data blocks between storage nodes to match changes in workload patterns on the storage nodes.

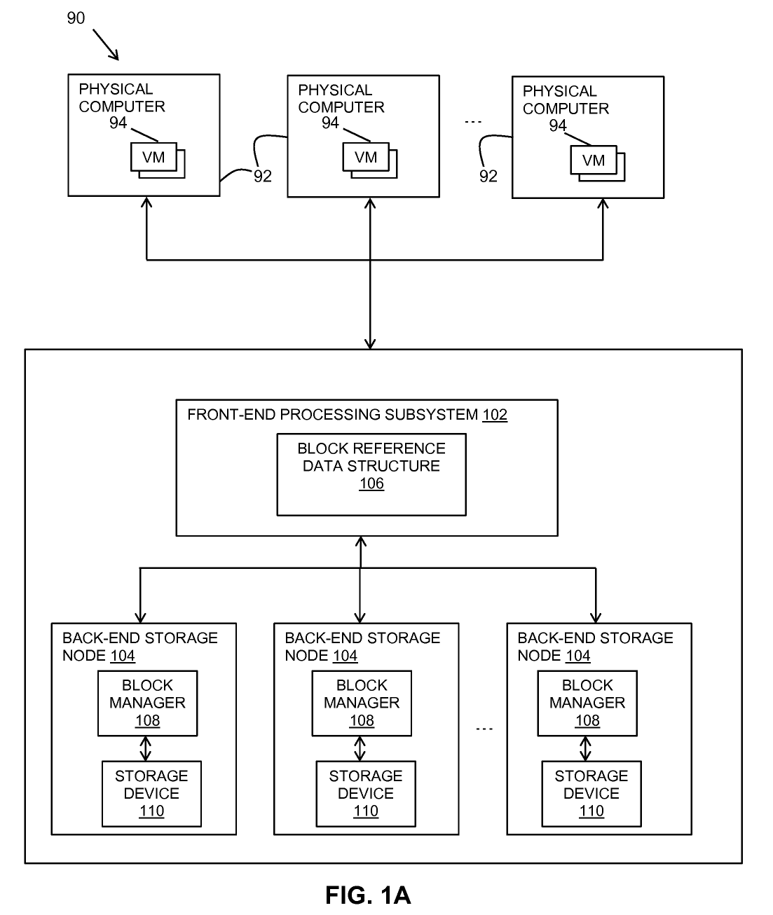

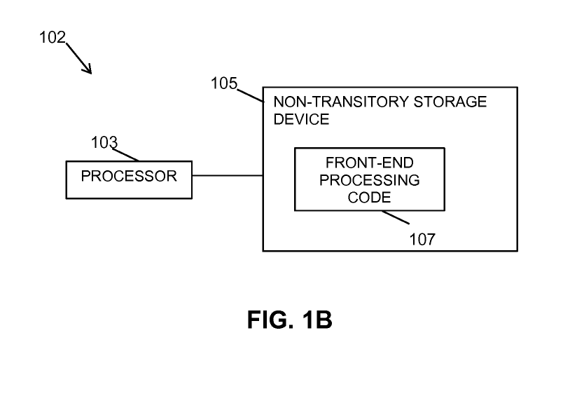

FIG. 1A shows a system 90 in which one or more physical computers 92 are able to access a storage system 100. Each physical computer 92 may host one or more virtual machines 94 or no virtual machines if desired. Each physical machine 92 and/or virtual machine 94 may perform read and write transactions to the storage system 100.

The storage 100 may be implemented as a block level storage system. As such, the physical and virtual machines 92, 94 may perform block level access requests to the storage system 100.

The illustrative storage system 100 shown in FIG. 1A includes a front-end processing subsystem 102 coupled to one or more back-end storage nodes 104. Referring briefly to FIG. 1B, an example of a front-end processing subsystem 102 includes a processor 103 coupled to a non-transitory storage device 105 (e.g., hard drive, random access memory, etc.). The non-transitory storage device 105 stores front-end processing code 107 that is executable by the processor 103. The code 107 imparts the processor 103 with some or all of the functionality described herein attributed to the front-end processing subsystem 102.

Each back-end storage node 104 may include a block manager 108 which access a storage device 110 (e.g., a hard disk drive). The block manager 108 may be implemented as a hardware processor that executes code. In some implementations, each block manager 108 comprises a “thin” database performing independently of thin databases associated with other block managers (i.e., not a distributed database). An example of a thin database is one that is capable only of creating, replicating, updating, and deleting records. The hardware implementation of FIG. 1B also can be used to implement the block manager 108 in some embodiments (with code 107 being replaced by database code).

In general, the front-end processing subsystem 102 receives block access requests from the various physical and/or virtual machines 92, 94 and processes the requests for completion to the various back-end storage nodes 104.

Because in some implementations the block managers 108 comprise thin databases, the front-end processing subsystem 102 may perform at least some of the functionality that otherwise would have been performed by the back-end nodes 105 if more sophisticated databases had been used. Further, the storage system 100 is capable of data duplication, lazy replication, and other data storage functions. For the storage system 100 to be capable of such functionality, the front-end processing subsystem 102 implements various actions as described below.

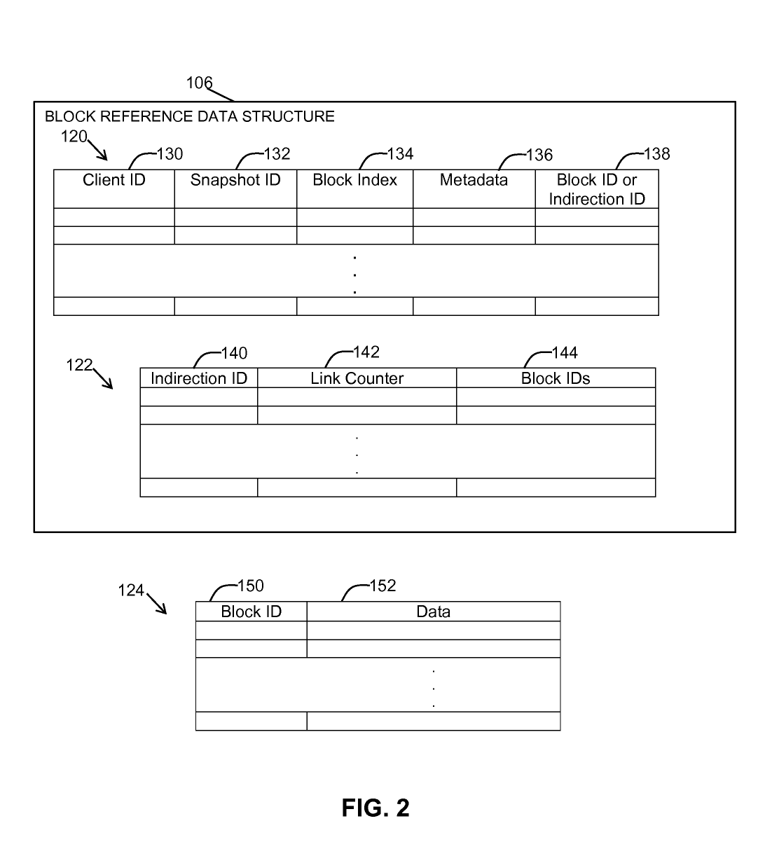

To perform one or more of the functions described below, the front-end processing subsystem 102 maintains and uses a block reference data structure 106. The block reference data structure 106 provides information on individual blocks of data and on which storage node each such block of data is stored. The block reference data structure 106 enables the storage system to provide load balancing, redundancy and scalability. An example of a block reference data structure 106 is illustrated in FIG. 2. In the example of Figure, the block reference data structure 106 comprises multiple tables 120 and 122. Table 120 is referred to as a primary block reference table. Table 122 is referred to as a secondary block reference table. Table 124 is referred to as a block storage table and is stored in the respective storage nodes. The information provided in tables 120-124 may be provided in a form other than tables in other embodiments.

The primary reference table 120 includes multiple entries with each entry including a client identifier (ID) 130, a snapshot ID 132, a block index value 134, metadata 136 and a field 138 containing a block ID or an indirection ID. The client ID 130 is a unique identifier of the virtual machine 94 or physical machine 96 that controls the data block referenced by the corresponding entry in the primary reference table 120. A snapshot is the state of the storage volume at a particular point in time. The snapshot ID 132 is a unique identifier of a snapshot within the machine to which the referenced data block belongs. The block index 134 is a unique identifier of the referenced block for a particular snapshot within the virtual machine. The metadata 136 comprises information associated with the data block. Examples of metadata 136 include such items of information as: process ID, user credential and timestamp at block modification, and replication status.

Field 138 comprises either a block ID or an indirection ID. A block ID is a reference to an actual back-end storage node 104 and to a physical location within that storage node where the referenced data block is actually stored. If the referenced data block is one of multiple copies of the data in the storage system 100, an indirection ID is used in field 138 instead of a block ID. An indirection ID comprises a pointer to an entry in the secondary reference table 122.

The secondary reference table 122 is used to keep track of various copies of a data block. The indirection ID 140 contains the same value as at least one of the indirection IDs 138 in the primary reference table 120. The link counter 142 comprises a count value of the number of associated block IDs in field 144. The link counter 142 thus is indicative of the number of additional copies of an identical data block. In accordance with some examples, each time a snapshot of a volume is made, the associated link counter of every block in the volume is incremented. If a snapshot image is deleted, the corresponding link counters are decremented. If the block is unique, then the link counter may be set to a value of 1. The block IDs in field 144 comprise references to the data blocks on the back-end storage nodes 104 and locations within each node as to where the data block is actually resident.

The block storage table 124 comprises fields 150 and 152. Field 150 contains a block ID and field 152 contains the actual data corresponding to the associated block ID.

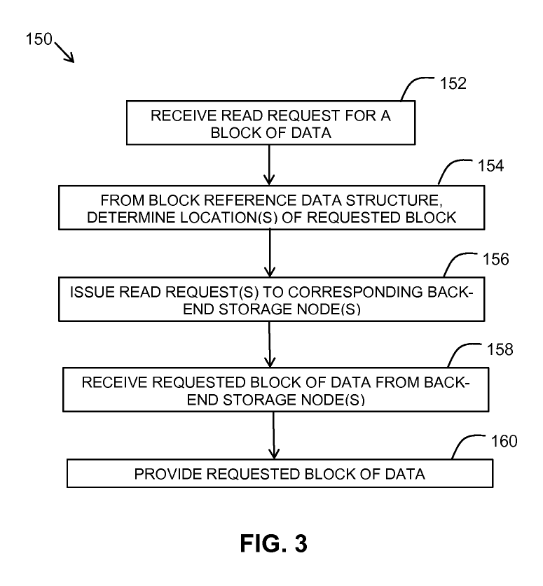

FIG. 3 is directed to a method 150 performed by the storage system 100 for a read transaction. The various actions of method 150 may be performed in the order shown or in a different order. Further, two or more of the actions may be performed in parallel. The actions of method 150 may be performed by the front-end processing subsystem 102 of the storage system 100.

At 152, the method comprises receiving a read request for a block of data. The read request is received by the front-end processing subsystem 102 from one or more of the physical or virtual machines 92, 94.

At 154, the method comprises accessing the block reference data structure 106 and, from the data structure, determining the location(s) of the requested data block. For example, the method may include retrieving the block ID or indirection ID from the primary reference table 120. If the ID is an indirection ID, the method may include obtaining a corresponding block ID(s) from the secondary reference table 122. It may be that the requested data block is present in the form of multiple copies on the various back-end storage nodes 104. The block reference data structure 106 is accessed to determine the number of copies present of the targeted data block and their location on the storage nodes 104. For example, primary reference block reference table 120 may include a block ID or an indirection ID as noted above. If a block ID is present, then the targeted data can be read from back-end storage node referenced by that particular block ID. The front-end processing subsystem 102 issues a read request to that particular storage node at 156.

On the other hand, if an indirection ID is present, then using the indirection ID, the front-end storage subsystem 102 consults the secondary block reference table 122 and reads the link counter 142. The link counter indicates the number of copies of the targeted data block. The block IDs 144 of the corresponding data blocks are also read from secondary block reference table 122. Read requests are issued (156) by the front-end processing subsystem 102 to the various back-end storage nodes 104 that contain a copy of the data block targeted by the initial read request. How quickly a given back-end storage node 104 responds to the front-end processing subsystem 102 with the requested data may vary from storage node to storage node.

The front-end processing subsystem 102 receives the requested data from the storage nodes 104 that received the read requests as explained above. If only a single back-end storage node 104 was issued a read request by the front-end storage subsystem 102, then as soon as the targeted data is provided back to the front-end processing subsystem 102, the front-end processing subsystem 102 returns that data to the physical or virtual machine that originated the read request in the first place. If multiple back-end storage nodes 104 were issued a request as noted above, the front-end processing subsystem 102 returns the data to the physical or virtual machine 92, 94 from whichever back-end storage node 104 first responded to the front-end storage subsystem 102 with the requested data.

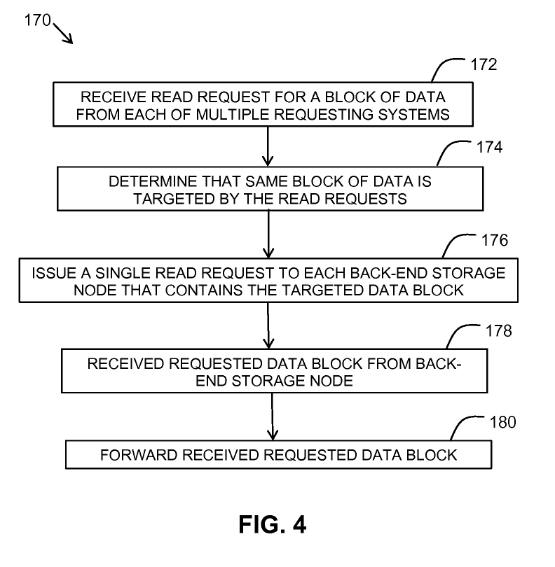

FIG. 4 also is directed to read transactions. In FIG. 4, the method 170 is directed to a situation in which multiple physical or virtual machines 92, 84 attempt to read the same data block at generally the same time. The front-end processing subsystem 102 recognizes the attempt by multiple physical or virtual machines to read the same data block (e.g., by identifying concurrent requests to the same block or indirection ID) and, rather than issuing multiple read requests to the back-end storage nodes for each incoming read request, the front-end processing subsystem 102 issues a single read request to each back-end storage node 104 that contains a copy of the request data.

The various actions of method 170 may be performed in the order shown or in a different order. Further, two or more of the actions may be performed in parallel. The actions of method 170 may be performed by the front-end processing subsystem 102 of the storage system 100.

At 172, the method 170 comprises receiving a read request for a block of data from each of multiple requesting systems (e.g., physical machines 92, virtual machines 94). The read requests are received by the front-end processing subsystem 102 from multiple physical or virtual machines 92, 94.

At 174, the front-end processing subsystem 102 determines that the same block of data is being targeted by multiple concurrent read requests. At 176, the front-end processing subsystem 102 issues a single read request to each back-end storage node 104 that contains the targeted data block. The front-end processing subsystem 102 determines which nodes contain the targeted data block from the block reference data structure 106.

At 178, the method further comprises the front-end processing subsystem 102 receiving the requested data from one or more of the back-end storage nodes and, at 180 forwarding the first (or only) received targeted data back to the physical or virtual machines 92, 94 that originated the read requests in the first place.

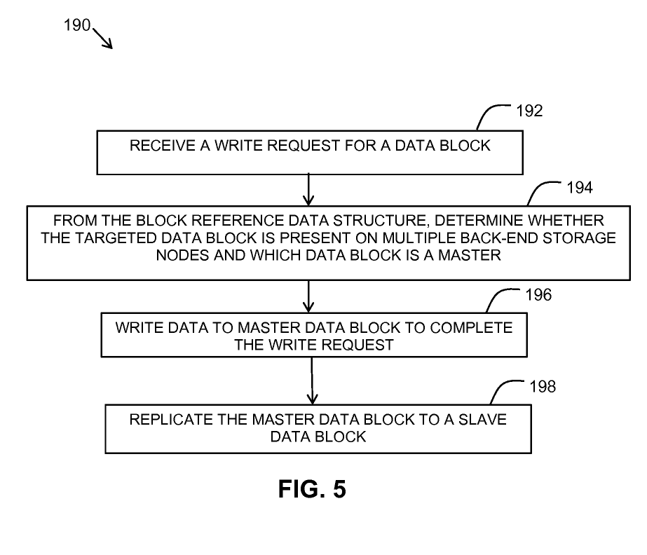

FIG. 5 provides a method 190 directed to a write transaction. The various actions of method 190 may be performed in the order shown or in a different order. Further, two or more of the actions may be performed in parallel. The actions of method 190 may be performed by the front-end processing subsystem 102 of the storage system 100.

At 192, the method comprises the front-end processing subsystem 102 receiving a write request from a physical or virtual machine 92, 94. At 194, based on the block reference data structure, the front-end processing subsystem 102 determines whether the targeted data block is present on multiple back-end storage nodes 104. If multiple back-end storage nodes 104 contain the data block targeted by the write transaction, the front-end processing subsystem 102 determines which of the multiple copies of the targeted data block is the “master” data block. In some implementations, the write transaction completes to only master data block, and not to the other copies (i.e., the slave data blocks). The metadata 136 may include sufficient information from which the block determined to be the master data block can be ascertained.

At 196, the front-end processing subsystem 102 then completes the write transaction to the back-end storage node 104 that contains the data block determined to be the master data block. At 198, the front-end storage subsystem 102 replicates the data block determined to be the master data block to all other copies of the data block on the other storage nodes 104. This block replication process may be performed in the background and at a slower pace than the initial write to the master data block. As such, the replication from the master data block to the slave data blocks may be referred to as “lazy replication” and provides the storage system 100 with redundancy capabilities.

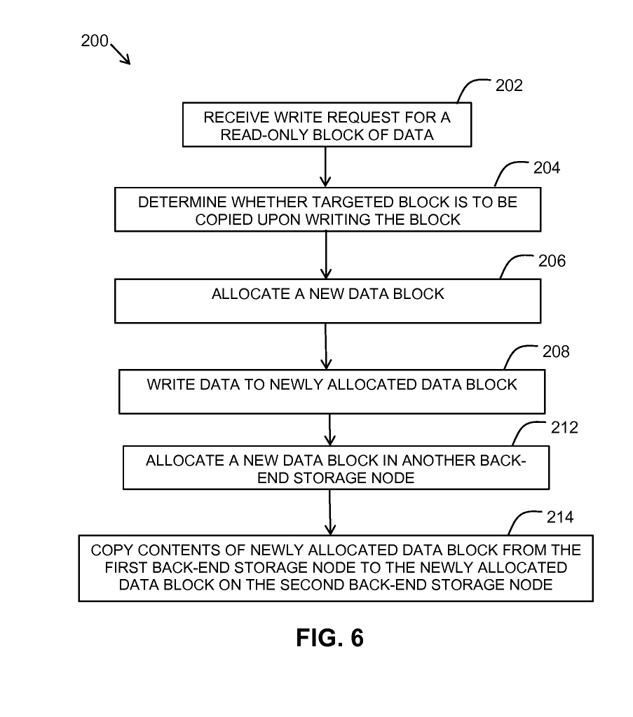

FIG. 6 provides a method 200 directed to a write transaction directed to a read-only block. A data block may be designated as read-only because, for example, the data block may be shared by multiple physical or virtual machines 92, 94. Multiple copies of the data block are present on the storage node 104, and all are designed as read-only. If a data block is shared, none of the sharing physical/virtual machines may be permitted to perform a write transaction to their copy of the data block to avoid a data coherency problem. In order to perform a write transaction to a read-only shared data block, the data block first is replicated and sharing ceased.

The various actions of method 200 may be performed in the order shown or in a different order. Further, two or more of the actions may be performed in parallel. The actions of method 200 may be performed by the front-end processing subsystem 102 of the storage system 100.

At 202, the method comprises the front-end processing subsystem 102 receiving a write request for a read-only data block present on a first back-end storage node 104. At 204, the front-end processing subsystem 102 determines whether the targeted block is a “copy-on-write” block meaning a block that should be copied upon performing a write transaction to the block. All shared blocks may be designated as copy-on-write in which case the link counter is greater than 1.

At 206, if the targeted data block on the first back-end storage node 104 is a COW data block, then the front-end processing subsystem 102 allocates a new data block on the first back-end storage node 104. The newly allocated data block is designated as readable and writeable (“RW”). At 208, the front-end processing subsystem 102 writes the data included with the received write transaction to the newly allocated RW data block.

At 212, the front-end processing subsystem 102 also allocates a RW copy of the data block present on a second back-end storage node 104, and then begins to copy the contents of the newly allocated block from the first storage node to the newly allocated block on the second storage node. Copying may occur or continue to occur after the initial write of the data to at 208 has completed.

The storage system 100 described herein is scalable because additional storage nodes 104 with, for example, thin databases, can easily be added and the front-end processing subsystem 102 keeps track of the various storage nodes 104 through its block reference data structure 106. Thus, the storage system 100 can be readily used in a cloud environment. The block reference data structure 106 enables fast indexing over large storage capacity. The various back-end storage nodes 104 represent distributed storage over multiple physical nodes, which is not readily achievable in a standard database environment. Also, the storage system 100 enables efficient reclaiming of deleted storage space.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A storage system, comprising:
a front-end processing subsystem to receive block level storage requests; and
a plurality of back-end storage nodes coupled to said front-end subsystem, each of said back-end storage nodes comprising a storage device and an independent block manager to create, read, update and delete data blocks on said storage device;
wherein said front-end processing subsystem is to maintain a block reference data structure that is usable by the front-end processing subsystem to access the back-end data storage nodes to provide balancing, redundancy, and scalability to the storage system.

2. The storage system of claim 2 wherein said block reference data structure includes a primary block reference table that includes a reference for each data block stored on the plurality of back-end storage subsystems.

3. The storage system of claim 2 wherein each reference includes a client identifier, a snapshot identifier and a block index.

4. The storage system of claim 2 wherein for a block of data that is resident on the storage devices in multiple instances, the primary block reference table includes an indirection identifier to a secondary block reference table.

5. The storage system of claim 4 wherein the secondary block reference table includes an indirection identifier, a link counter, and one or more block identifiers.

6. The storage system of claim 5 wherein the link counter includes a count value that is indicative of the number of instances of copies of a data block on the storage devices.

7. The storage system of claim 6 wherein the one or more block identifiers include a block identifier for each of the instances of the data block.

8. The storage system of claim 1 wherein the front-end processing subsystem receives a read request for a block of data, determines from the block reference tables whether the requested block is stored as multiple copies on the back-end storage subsystem, and issues a request to each back-end storage node determined from the block reference data structure to store a copy of the requested data.

9. The storage system of claim 1 wherein the front-end processing subsystem receives a read request for a block of data from each of multiple requesting systems, determines that the same block of data is targeted by the read requests, and issues a single read request to each back-end storage node containing the targeted block as determined from the block reference data structure.

10. The storage system of claim 1 wherein each of a plurality of back-end storage subsystems store a copy of a block of data and the front-end processing subsystem receives a write request for the block of data, writes to one of said copies, and causes the contents of the one copy to be replicated to all other copies of said block of data.

11. The storage system of claim 1 wherein each of a plurality of back-end storage subsystem store a copy of a read-only copy-on-write (RO COW) block of data, and the front-end processing subsystem receives a write request targeting the RO COW data block and, in response to receiving said write request, said front-end storage subsystem allocates a new data block on each of the plurality of back-end storage subsystems, writes to one of the newly allocated data blocks and causes the written data block to be replicated to all other newly allocated data blocks.

12. A storage system, comprising:
a front-end processing subsystem to receive block level storage requests; and
a plurality of back-end storage nodes coupled to said front-end subsystem, each back-end storage subsystem comprising a storage device and an independent block manager to create, read, update and delete data blocks on said storage node;
wherein said front-end processing subsystem is to access a block reference data structure to access the back-end data storage systems to determine which back-end storage nodes to access to complete received block level storage requests.

13. The storage system of claim 12 wherein said block reference data structure includes a primary block reference table that includes a reference for each data block stored on the plurality of back-end storage subsystems and a secondary block reference table that, for a block of data that is resident on the storage subsystems in multiple instances, the primary block reference table includes an indirection identifier to the secondary block reference table.

14. A method, comprising:
receiving a write block access request for a read-only block of data;
determining whether the block of data is to be copied upon writing the block of data;
allocating a first new block of data on a first back-end storage node;
writing the data to the first new allocated block of data;
allocating a second new block of data on another back-end storage node; and
copying contents of the first new allocated block of data from the first back-end storage node to the second new allocated block of data on the other back-end storage node.

15. The method of claim 14 wherein copying the contents of the first new allocated block of data from the first back-end storage node to the second new allocated block of data on the other back-end storage node may occur or continue to occur after writing to the first new allocated block of data has completed.
